(19) United States
(12) Patent Application Publication
(10) Pub. No.: US 2002/0067490 A1
(43) Pub. Date: Jun. 6, 2002

(54) Pattern inspecting apparatus, pattern inspecting method, aligner, and method of manufacturing electronic device

(76) Inventor: Kouki Okawauchi, Kanagawa (JP)

Correspondence Address: RADER, FISHMAN & GRAUER, P.L.L.C., Suite 501, 1233 20th Street, N.W., Washington, DC, 20036, US

(21) Appl. No.: 09/983,583

(22) Filed: Oct. 25, 2001

(30) Foreign Application Priority Data
Oct. 26, 2000 (JP) P2000-326452
Nov. 22, 2000 (JP) P2000-355192

(51) Int. Cl. G01B 11/14

(52) U.S. Cl. 356/614

(57) ABSTRACT

Disclosed is an overlapping precision measuring apparatus for constituting the inventive pattern inspection apparatus, which is capable of accurately inspecting overlapped condition of aluminum wiring pattern and resist pattern formed on a semiconductor wafer even in presence of a stepped gap. The inventive pattern inspecting apparatus comprises the following: an optical frequency shifter for splitting a laser beam emitted from a laser-beam emitting source into a plurality of frequencies; an optical means such as an object lens for condensing laser beams comprising plural frequencies split via the optical frequency shifter towards a specific pattern subject to inspection; an optical detector for receiving reflected laser beams comprising plural frequencies irradiated onto a pattern subject to inspection via an optical means; and an analyzer for analyzing actual position of the pattern subject to inspection based on the reflected laser beams received by the optical detector.

### CROSS REFERENCES TO RELATED APPLICATIONS

The present document is based on Japanese Priority Document JP 2000-355192, filed on Nov. 22, 2000 and on Japanese Priority Document JP 2000-326452, filed on Oct. 26, 2000, both in the Japanese Patent Office, the entire contents of which being incorporated herein by reference.

### BACKGROUND OF THE INVENTION

1. Field of the Invention

The present invention relates to a pattern inspecting apparatus for verifying alignment precision via detection of a pattern formed on a substrate. The present invention further relates to a method of inspecting pattern and also to an aligner. The present invention further relates to a method of manufacturing an electronic device.

2. Description of the Related Art

In order to inspect an overlapped condition of individual patterns in a semiconductor device, in other words, in order to inspect displacement of individual patterns as a result of overlapping, it has been a conventional practice to measure overlapping precision of individual patterns by way of detecting such displacement measuring marks, so-called box marks, formed on a semiconductor wafer, for example. In such a practice, the box mark is detected by applying two-dimensional picture images in such a manner that a semiconductor wafer alignment is detected by a light from a light source utilizing visible area and the displacement measuring mark (box mark) is detected by a light from another light source utilizing an ultraviolet area.

FIG. 4 designates a schematic block diagram for explanatory of essential components of a conventional two-dimensional picture image pattern inspecting apparatus for inspecting displacement of overlapped patterns. In this inspecting apparatus, it is so arranged that, in order to measure semiconductor wafer alignment and box marks BM of a rough pattern, a semiconductor wafer HW is irradiated with a visible light from a visible light source 10 via a lens 20, a half-mirror 30, and a visible light object lens 40 for causing a reflected light to be received by a camera 60 via the visible light object lens 40, the half-mirror 30, and an image-focusing lens 50.

Further, in order to measure such box marks BM used for ultra fine patterning of a transistor gate or a memory cell, the semiconductor wafer HW is irradiated with ultraviolet rays from a ultraviolet light source 10′ via a lens 20′, a half-mirror 30′, and an ultraviolet light object lens 40′ to cause a reflected light to be received by the camera 60 via the ultraviolet light object lens 40′, the half-mirror 30′, and the image-focusing lens 50.

Nevertheless, in a case of utilizing the above pattern inspecting apparatus, whenever switching light sources from each other, the object lenses must also be switched from each other, and yet, use of the above inspecting apparatus also raises a variety of problems because of displaced patterns caused by switching operations, wear of the switching parts, and the time required for switching operations, for example.

FIG. 5A designates a plan view for explanatory of the configuration of the box marks used for the above pattern inspection, whereas FIG. 5B designates a cross-sectional view of the above box marks BM, which are serially and cubically formed on the dicing line of a semiconductor wafer HW relative to the formation of individual patterns during the process for manufacturing a semiconductor device.

For example, when inspecting displacement caused by a process for overlapping resist pattern and silicon oxide pattern, the above box marks comprise an inner box mark “a” (an internal square pattern) formed with a resist when forming a resist pattern and an outer box mark “b” (an external square pattern) formed with silicon oxide outside of the inner box mark “a” when forming a silicon oxide pattern.

FIG. 6 designates the relationship between the box marks and contrast waveforms generated from the light image reflected from the box marks. Concretely, because of a stepped gap existing between the box marks and a semiconductor wafer, contrast waveforms generated from the reflected light image individually contain peaks at the stepped gap portions by way of accompanying variable brightness.

Because of this, in the pattern inspection process, initially, such a contrast waveform corresponding to one section of the reflected light image received by the camera 60 is searched before analyzing it. For example, by way of individually detecting positions of a bottom (i.e., an apex of peak) of the searched contrast waveform followed by a process to compute the X-directional and Y-directional positions of the inner box mark against the outer box mark, it is possible to detect displacement caused by the overlapping of the resist pattern and the silicon oxide pattern.

The X-directional displacement of the outer box mark against the inner box mark can be computed by applying an equation shown below, for example.

dX={(Xil+Xir)/2}−{(Xol+Xor)/2}

Likewise, Y-directional displacement of the outer box mark “b” against the inner box mark “a” can be computed by applying an equation shown below, for example.

dY={(Yil+Yir)/2}−{(Yol+Yor)/2}

Nevertheless, inasmuch as the above-referred conventional apparatus for inspecting a two-dimensional picture-image pattern inspects displacement of individual patterns due to overlapping by applying cubically formed box marks, it generates those problems cited below.

FIG. 7A exemplifies such a process for manufacturing a semiconductor device comprising a laminated-film structure. FIG. 7A specifically exemplifies such a process for inspecting displacement caused by superposition of a resist pattern RP upon an aluminum wiring pattern AP formed on a silicon oxide pattern SP on a semiconductor wafer HW during the aluminum wiring process.

In the above example, because of the covering property of aluminum, a contrast waveform based on the stepped gaps between the resist pattern RP and the aluminum wiring pattern AP becomes the one as shown in FIG. 7B.

As mentioned above, when operating such a conventional two dimensional picture image inspecting apparatus cited above, it is quite difficult to accurately detect positions of an edge of the resist pattern RP and an edge of the aluminum wiring pattern AP from the obtained contrast waveforms. Actually, the conventional practice presumes that the bottom (i.e., the apex of peak) of individual contrast waveforms corresponds to the edge thereof.

Because of this, result of inspecting the displacement of overlapped patterns easily generates error to cause the yield of eventual products to be lowered.

### SUMMARY OF THE INVENTION

The present invention has been consummated to fully solve the above problems. More particularly, the inventive pattern inspecting apparatus comprises an optical frequency shifter, an optical member, an optical detecting unit and an analyzing means. The optical frequency shifter splits frequency of laser beams emitted from a laser beam source into a plurality of different frequencies. The optical member is an object lens which causes laser beams comprising the plurality of frequencies split by the above optical frequency shifter to be condensed towards a pattern subject to inspection. The optical detecting device is an optical detector which receives reflected laser beams comprising the plurality of frequencies irradiated against the pattern subject to inspection via the object lens. The analyzing means is an analyzer which analyzes actual positions of such pattern subject to inspection based on the reflected light received by the optical detecting device.

The pattern inspecting apparatus may also comprise a visible laser light source and an observing device.

The present invention further provides a novel aligner (exposing apparatus) utilizing the inventive pattern inspecting apparatus.

According to the present invention, a laser beam emitted from a laser light source is split into laser beams having a plurality of different frequencies, and then, laser beams bearing the plurality of frequencies are condensed by the object lens before being irradiated onto the pattern subject to inspection. Next, reflected laser beams reflected from the pattern subject to inspection are detected by the optical detector. In this way, when the plurality of laser beams bearing different frequencies are condensed at the object lens and are irradiated onto the pattern subject to inspection, focal positions via the object lens are variable by frequencies of individual laser beams. By way of analyzing the reflected laser beams reflected from the pattern, despite of the stepped gaps between those patterns subject to inspection, it is possible to accurately detect actual position of a corresponding pattern from picture images of the existing stepped gaps.

The present invention further provides a novel method of inspecting patterns comprising serial steps including the following:

a step of splitting laser beams emitted from a laser light source into a plurality of laser beams bearing different frequencies;

a step of condensing a plurality of laser beams bearing different frequencies towards a pattern subject to inspection followed by a step of irradiating the condensed laser beams onto the pattern;

a step of receiving each of reflected laser beams comprising a variety of frequencies reflected from the pattern subject to inspection; and

a step of analyzing actual positions of those patterns subject to inspection from picture image in accordance with individual reflected laser beams.

The present invention further provides a novel method of manufacturing an electronic device by way of utilizing the above referred method of inspecting patterns, or a method of manufacturing an electronic device, which repeats light exposure based on the pattern analyzed via the above pattern inspecting method.

According to the present invention, initially, laser beams bearing a predetermined frequency is split into a plurality of laser beams bearing different frequencies, and then, those laser beams bearing different frequencies are condensed onto such pattern subject to inspection before irradiating them onto the pattern. By virtue of this arrangement, focal positions of individual laser beams are variable by frequencies. Further, by way of analyzing those reflected laser beams, even though there are some stepped gaps between those patterns subject to inspection, it is possible to accurately detect actual positions of patterns from picture image corresponding to the stepped gaps.

According to the present invention, there are provided a variety of advantageous effects. Concretely, even when dealing with such patterns with stepped gaps, the inventive overlapping precision measuring apparatus accurately inspects the overlapping precision, and yet, it also makes it possible to accurately inspect a variety of patterns in a short period of time, whereby preventing actual yield of the eventual products from being lowered.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 designates a schematic block diagram of an overlapping precision measuring apparatus for exemplifying an example of the pattern inspecting apparatus according to an embodiment of the present invention;

FIG. 2 designates a diagram for explanatory of the relationship between a cross section of a semiconductor device comprising a laminated film structure and contrast waveforms;

FIG. 3 designates a schematic diagram for explanatory of the relationship between laser beams bearing different frequencies and the focal positions;

FIG. 4 designates a schematic block diagram for explanatory of a conventional pattern inspecting apparatus;

FIG. 5A designates a plan view of inner and outer box marks; whereas

FIG. 5B designates a cross-sectional view of the inner and outer box marks shown in FIG. 5A;

FIG. 6 designates a diagram for explanatory of the relationship between the box marks and the contrast waveforms obtained from an image generated by reflected laser beams; and

FIG. 7 designates a diagram for explanatory of the relationship between a cross section of a semiconductor device comprising a laminated film construction and a contrast waveform thereof.

### DESCRIPTION OF THE PREFERRED EMBODIMENTS

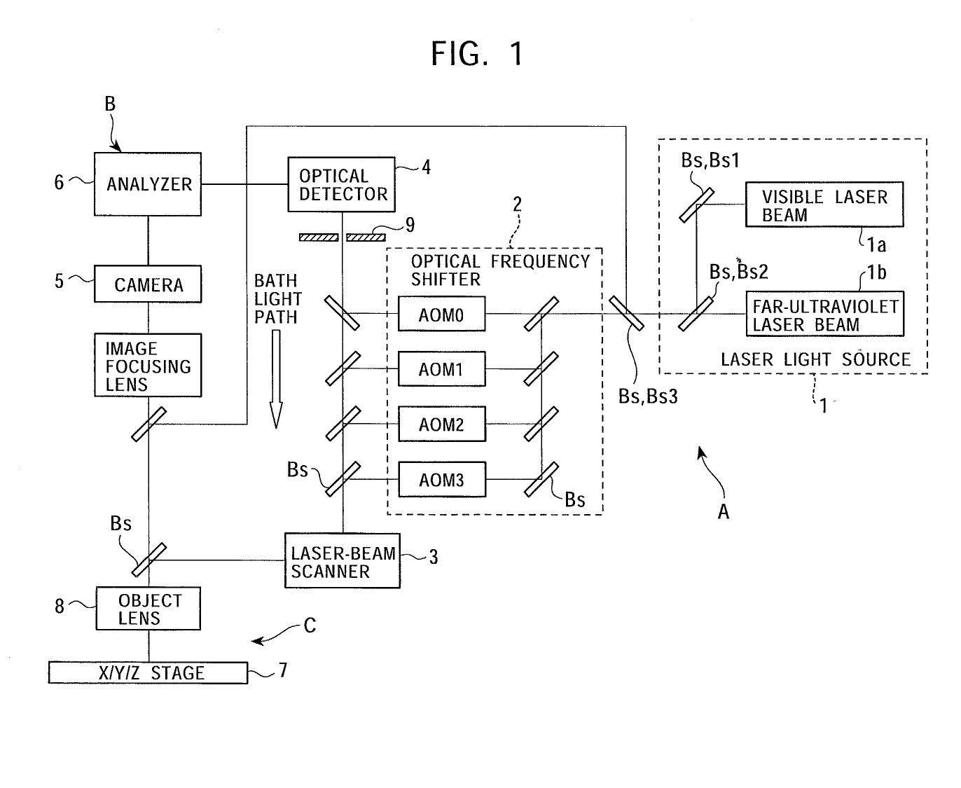

Referring now to the accompanying drawings, practical forms for implementing the present invention will be described below. FIG. 1 designates a simplified schematic block diagram for explanatory of the construction of an overlapping precision measuring apparatus for exemplifying an example of the pattern inspecting apparatus according to an embodiment of the present invention.

More particularly, the above-referred overlapping precision measuring apparatus mainly comprises a scanning-type confocal microscope A, an analyzer unit B, and a stage unit C which is capable of controlling X-directional and Y-directional shift with high precision, which is used for mounting a semiconductor wafer.

The scanning-type confocal microscope A comprises the following: a laser light source 1 capable of emitting a far-ultraviolet laser beam and a visible laser beam, an optical frequency shifter 2 for shifting frequency of laser beams, a laser beam scanner 3 for scanning emitted laser beams, an optical detector 4, a camera 5, an object lens 8, and a confocal pin hole 9. The above scanning-type confocal microscope A is fitted with an analyzer 6 for constituting the above-referred analyzer unit B and an X/Y/Z stage 7 for constituting the above-referred stage unit C for mounting a semiconductor wafer HW.

In the overlapping precision measuring apparatus, for example, such a semiconductor wafer (an object of inspection) HW comprising the laminated-film structure is mounted on the X/Y/Z stage 7. Next, the laser beam scanner 3 scans laser beams bearing such frequencies shifted by the optical frequency shifter 2, and then causes the semiconductor wafer HW to be irradiated with the frequency shifted laser beams via the object lens 8.

Next, the optical detector 4 receives laser beams (detected beams) reflected from the semiconductor wafer HW via the object lens 8 in conjunction with reference beams each having own frequency being shifted at the optical frequency shifter 2 through the confocal pin hole 9. The analyzer 6 functioning as a measuring means then analyzes the laser beams output from the optical detector 4. By virtue of this arrangement, it is possible to measure overlapping precision of individual patterns for forming a laminated film structure.

The laser light source 1 comprises a visible laser light source 1a capable of outputting a visible laser beam within a visible beam band and a far ultraviolet laser light source 1b capable of outputting a far ultraviolet laser beam within a far ultraviolet ray band having a relatively short wave length. The laser light source 1 incorporates such a mechanism capable of selectively emitting visible laser beams and far ultraviolet laser beams depending on the kinds of inspection objects, inspection uses, and the like.

A plurality of beam splitters Bs are disposed in the light path of the laser beams emitted from the visible laser light source 1a and the far ultraviolet laser light source 1b. Laser beams output from the visible laser light source 1a are reflected by beam splitters Bs1, Bs2, and Bs3, and then routed to a predetermined light path out of the laser light source 1 before eventually being incident upon the object lens 8 in a batch. On the other hand, far ultraviolet laser beams output from the far ultraviolet laser light source 1b individually permeate through the beam splitters Bs and Bs3 and then the ultraviolet laser beams are output to a predetermined light path out of the laser light source 1 before eventually being incident upon the optical frequency shifter 2.

The above-referred laser beam scanner 3 is fitted with a Galvano mirror or an ultra-sonic light deflecting element, for example. Illustration of the laser-beam scanner 3 is omitted.

After splitting the far ultraviolet laser beams emitted from the laser light source 1 into two parts, the above-referred optical frequency shifter 2 causes individual ultraviolet laser beams to be incident upon acousto-optic modulators (AOM) AOM 0, AOM1, AOM2, and AOM3, and then, by way of adding different ultra-sonic frequencies, it is possible for these laser beams emitted from the above acousto-optic modulators to gain such laser beams having specific optical frequencies different from that of the beams incident upon those acousto-optic modulators.

When implementing the present invention, initially, the above laser scanner 3 scans those laser beams generated via the acousto-optic modulators AOM1, AOM2, and AOM3, and then irradiates the scanned laser beams upon the semiconductor wafer HW via the object lens 8. Next, via the object lens 8, a laser beam (detected beam) reflected from the above semiconductor wafer HW is superposed with a reference beam having own frequency being shifted by the acousto-optic modulator AOM0 of the optical frequency shifter 2. Next, an optical beat obtained from thus-superposed beams in which beam intensity to be variable by differential frequencies via passage of time is received by the optical detector 4 via the confocal pin hole 9. Finally, the analyzer 6 functioning itself as a measuring means analyzes an output from the optical detector 4.

The camera 5 observes a batch light picture image under illumination when laser beams emitted from the laser light source 1 is directly incident upon the object lens 8, and yet, it also observes a light picture image of light such as a lamp.

Based on the reflected laser beams comprising a variety of frequencies received by the optical detector 4, the analyzer 6 analyzes displaced positions i.e., overlapped condition of individual patterns due to overlapping via the image processing process.

By way of utilizing such a proper lens complete with correction of chromatic aberration and other aberration factors across an extensive wave-length range from ultraviolet bands to visible ray bands, the above object lens 8 is capable of performing inspection with high precision at a faster rate without switching with another lens. For reference, it is suggested that such a lens as the one disclosed in the Japanese Patent Application Laid-Open No. HEISEI-11-167067/1999 may also be utilized for constituting the above object lens 8.

Next, a practical method for inspecting overlapped condition of individual patterns by applying the above-described overlapping precision measuring apparatus will be described below.

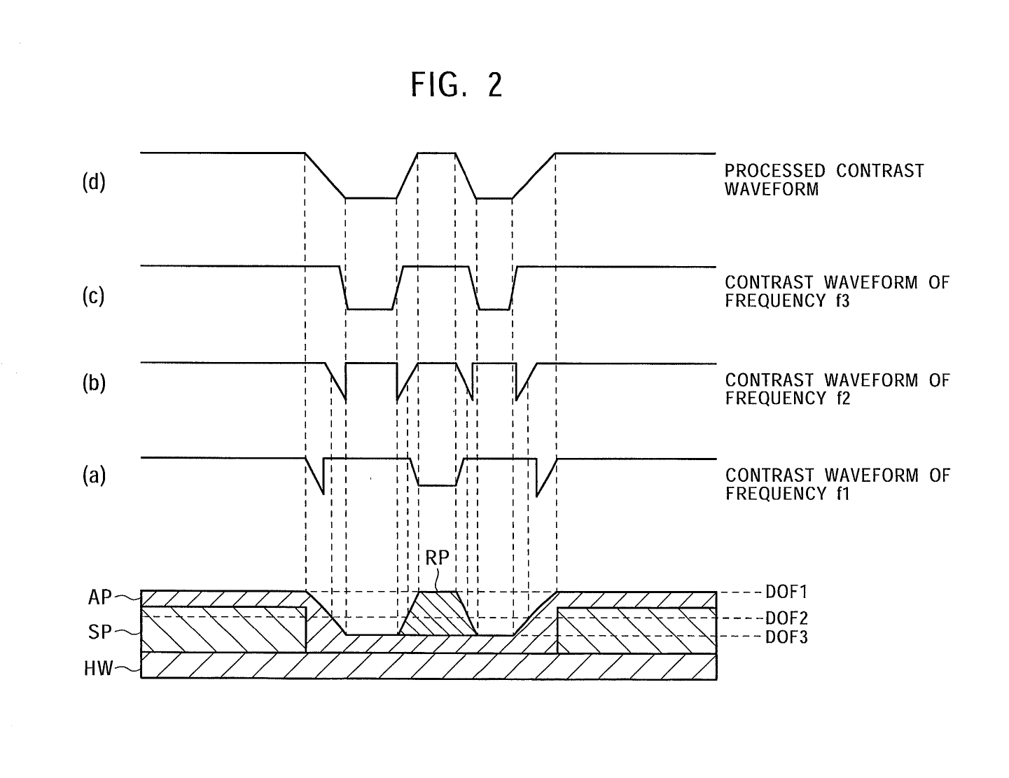

First, by referring to FIG. 2, such an example is described below, in which an inspection is carried out to detect positional displacement caused by superposition of the resist pattern RP upon the aluminum wiring pattern AP on the silicon oxide pattern SP on the semiconductor wafer HW in the course of processing an integrated circuit such as in the aluminum wiring process during the process for manufacturing a semiconductor device comprising a laminated film structure. Note that, unless specifically designated, such reference numerals not shown in FIG. 2 but used in the description below shall refer to those which are shown in FIG. 1.

Initially, a semiconductor wafer HW is mounted on the above referred X/Y/Z stage 7 of the overlapping precision measuring apparatus shown in FIG. 1. Next, a surface of the semiconductor wafer HW is irradiated with a visible laser beam emitted from the visible laser light source 1a via the object lens 8. In accordance with the picture image of the semiconductor wafer HW focused in the camera 5, a wafer alignment process is executed. Then, the X/Y/Z stage 7 is shifted to the position for measuring the positional displacement caused by the overlapping of the aluminum wiring pattern AP and the resist pattern RP.

While this condition remains, initially, the laser beam scanner 3 scans far-ultraviolet laser beams (containing frequencies f1, f2, and f3) shifted by the acousto-optic modulators AOM1, AOM2, and AOM3 of the optical frequency shifter 2, and then, the semiconductor wafer HW is irradiated with those far-ultraviolet laser beams via the object lens 8.

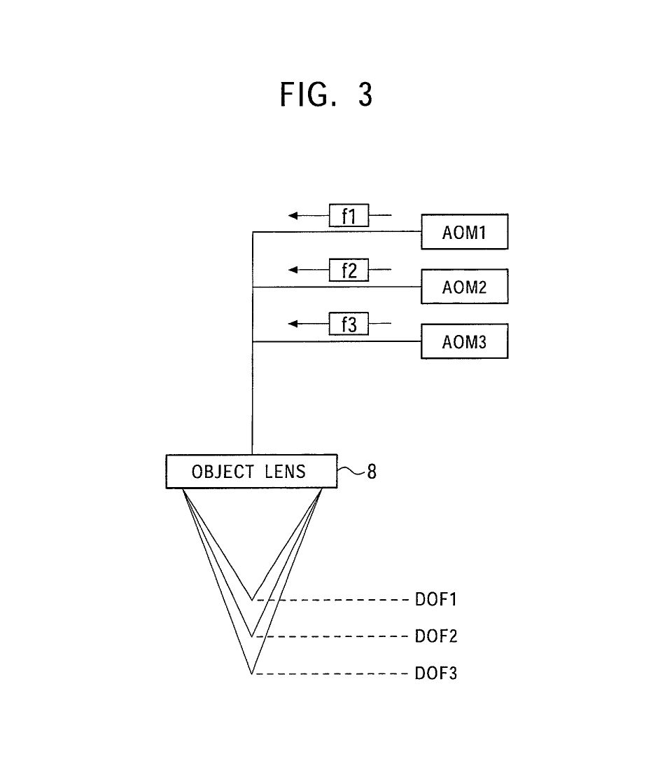

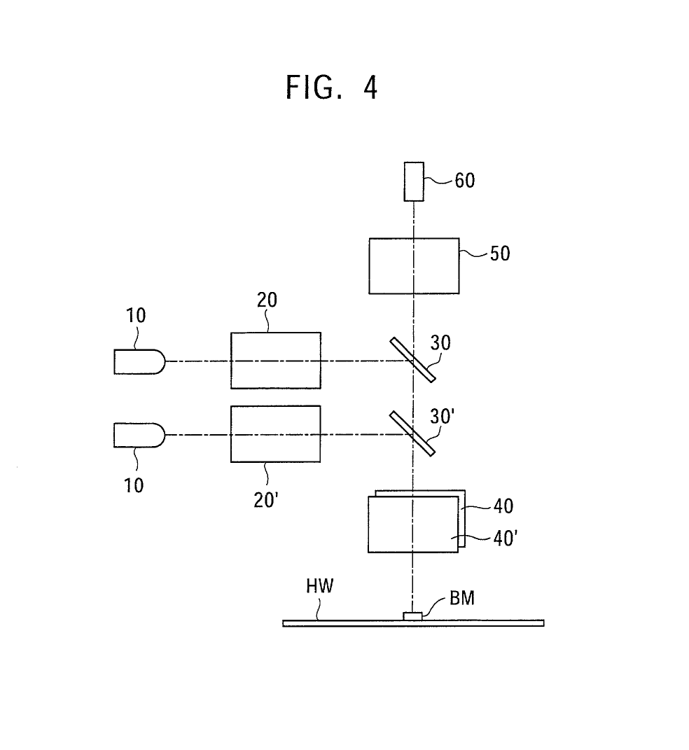

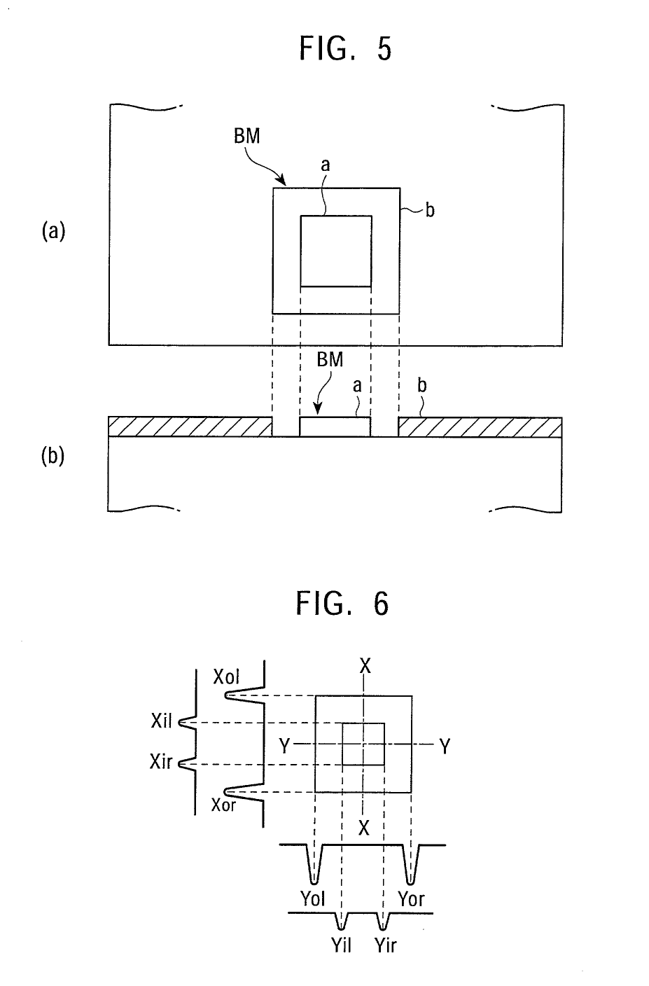

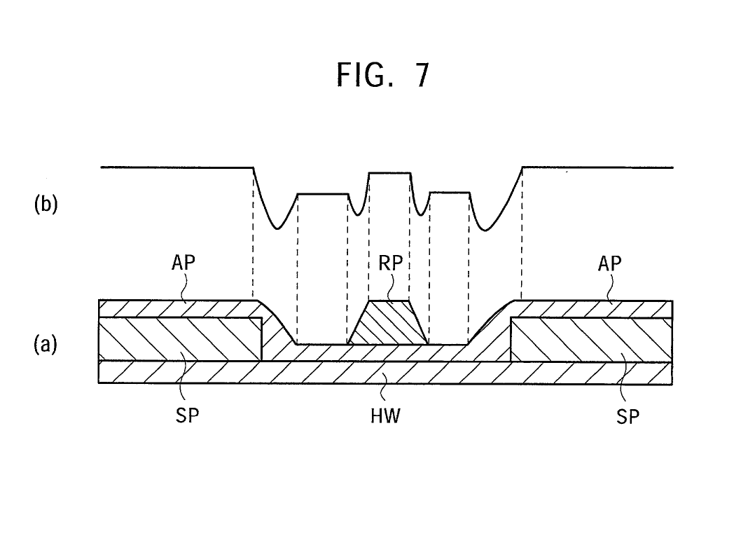

Individual far-ultraviolet laser beams containing frequencies f1, f2, and f3 irradiated upon the semiconductor wafer HW via the object lens 8 respectively bear mutually different focal points (multiple focal points) corresponding to individual frequencies against the surface of the semiconductor wafer HW as shown in FIG. 3.

The relationship between frequencies of individual far-ultraviolet laser beams and the focal positions (focal depth) is determined based on those equations shown below.

DOF=λ/NA² (1),

where DOF is a focal depth, λ is a wave-length, and NA is a numerical aperture.

V=f×λ (2),

where V is an optical velocity, “f” is a frequency, and λ is a wave-length.

Based on the above equations (1) and (2), the relationship between individual frequencies and the focal position (focal depth) can be expressed by an equation (3) shown below.

DOF=V/(f×NA²) (3)

Referring to the above equation (3), assuming that V=3×10⁸ m/s., NA=0.9, f1=4×10¹⁵ Hz, f2=2×10¹⁵ Hz, and f3=1×10¹⁵ Hz, then, a focal distance of the frequency f1 corresponds to DOF 1≈92 mm, a focal distance of the frequency f2 corresponds to DOF 2≈185 mm, and a focal distance of the frequency f3 corresponds to DOF 3≈370 mm. By way of varying frequency of laser beams, it is possible to vary focal positions of individual laser beams.

Next, far-ultraviolet laser beams (detected beams) reflected from the semiconductor wafer HW are overlapped with reference beams having own frequencies being shifted by the acousto-optic modulators AOM0 of the optical frequency shifter 2 via the object lens 8, and then, the above-referred optical beat for causing optical intensity to be variable by differential frequencies via passage of time is detected by the optical detector 4. Such contrast waveforms at focal positions of the frequencies f1, f2, and f3 detected via the optical heterodyne detection individually correspond to those waveforms which are shown in FIGS. 2(a)˜2(c).

By way of analyzing those contrast waveforms shown in FIGS. 2(a)˜2(c) via the analyzer 6, such a contrast waveform reflecting cross sectional structure of pattern as shown in FIG. 2(d) can be generated.

Individual laser beams comprising the frequencies f1, f2, and f3, reflected from the semiconductor wafer HW individually contain specific data corresponding to stepped gaps of individual patterns for forming laminated film structure of the semiconductor wafer HW at individual focal positions. Accordingly, by way of analyzing contrast waveforms output from the optical detector 4, it is possible to determine actual edge positions of the stepped gaps of individual patterns.

Based on the above arrangement, by way of analyzing contrast waveforms output from the optical detector 4 at individual focal positions on the semiconductor wafer HW, an aluminum wiring pattern AL is detected, and then an edge, i.e., gap portion, of the aluminum wiring pattern AL is computed.

In the same way, a resist pattern RP is detected, and then an edge of the resist pattern RP is sought. Next, based on the detected edges of the aluminum wiring pattern AL and the resist pattern RP, actual amount of the positional displacement caused by the overlapping of the aluminum wiring pattern AL and the resist pattern RP is computed.

In order to compute actual amount of the positional displacement, such a method is conceivable, which computes difference between mutual center at the edge of the aluminum wiring pattern AL and the center between edges of the resist pattern RP, for example.

By way of further executing the above serial processes in the Y direction of the semiconductor wafer HW, it is possible to accurately inspect the overlapped condition of the aluminum wiring pattern AL and the resist pattern RP available for constituting a laminated film structure.

As described above, unlike such a conventional apparatus for measuring overlapping precision of two-dimensional picture image, the inventive overlapping precision measuring apparatus precisely detects such an aluminum wiring pattern AL and a resist pattern RP having a substantial stepped gap otherwise cannot precisely be effected by any of those conventional corresponding apparatuses. More particularly, optical resolution can be improved by way of utilizing a laser beam scanning type confocal microscope. And yet, three-dimensional measurement can be executed at real time via the above optical heterodyne detection and simultaneous detection of multiple focal points. Further, by way of detecting actual edge forms of individual patterns available for forming a laminated film structure on the semiconductor wafer, it is possible to accurately detect precision of the overlapped patterns.

In particular, according to the inventive overlapping precision measuring apparatus, in the production of modern semiconductor devices with finer configurations such as LSIs, for example, it is possible to easily inspect positional displacement caused by overlapping of individual patterns formed with leveled laminated film structure.

Further, by way of utilizing such a quality lens complete with correction of various aberration factors, in particular, correction of chromatic aberration across an extensive wave-length range from ultraviolet band to visible-ray band, when repeating alignment via visible laser beams and detection of patterns via ultraviolet rays, there is no need of replacing object lenses. Because of this, it is possible to prevent the aluminum wiring pattern and the resist pattern from incurring positional displacement caused by the switching of the object lens and also prevent the switching parts from being worn out, and yet, it is possible to save time otherwise required for the switching. In particular, when diameter of the semiconductor wafer expands, it is essential that the rounds of performing alignment on a piece of semiconductor wafer, using visible laser beams are incremental. Taking this into account, by way of omitting the step of replacing the object lens 8, it is also possible to drastically simplify the inspection processes.

The above embodiment of the present invention has introduced three of the acousto-optic modulators each functioning as an optical-frequency shifter. However, by way of further increasing the number of the acousto-optic modulators, it is possible to further improve the overlapping precision.

Further, it is also allowable to utilize such acousto-optic deflectors (AOD) or acousto-optic modulators comprising “surface acoustic wave” (SAW) elements for constituting the above optical frequency shifter.

Not only for inspecting positional displacement caused by overlapping of the aluminum wiring pattern and the resist pattern during the aluminum wiring process, but the inventive overlapping precision measuring apparatus is also applicable to such a case for inspecting overlapped precision of a variety of patterns for constituting a variety of laminated-film structures in a variety of manufacturing processes.

Further, by way of applying the inventive pattern inspecting apparatus comprising the above-described overlapping precision measuring apparatus to an aligner (exposing apparatus) such as a stepper, for example, it is also possible to perform an exposing process via highly precise overlapping, whereby making it possible to manufacture such electronic apparatuses including semiconductor apparatuses and a variety of display apparatuses, for example. Further, such patterns to be subject to inspection are not always restricted to those various patterns formed on a semiconductor wafer HW, but it may also include a variety of patterns formed on a substrate comprising a glass substrate used for an LCD display or such a substrate comprising other materials as well.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. A pattern inspecting apparatus, comprising:
an optical frequency shifter for splitting a laser beam emitted from a laser light source into a plurality of laser beams having different frequencies;
an optical member for condensing the plurality of laser beams comprising the different frequencies split by said optical frequency shifter towards a pattern subject to inspection;
an optical detector for receiving via said optical member reflected laser beams comprising a plurality of frequencies after irradiation onto the pattern subject to inspection; and
an analyzer for analyzing an actual position of the pattern subject to inspection in accordance with said reflected beam received by said optical detector.

2. The pattern inspecting apparatus according to claim 1, further comprising;
a visible laser light source for emitting a visible laser beam toward said optical member; and
an observing device for observing an image obtained from reflected beams reflected from the pattern subject to inspection,
wherein said optical member is capable of condensing the visible laser beam emitted from said visible laser light source in conjunction with said laser beams split into plural frequencies by said optical frequency shifter.

3. A method of inspecting pattern, comprising;
a step of splitting a laser beam emitted from a laser light source into a plurality of laser beams having different frequencies;
a step of initially condensing the plurality of laser beams each having different frequencies towards a pattern subject to inspection and irradiating the condensed laser beams onto the pattern subject to inspection; and
a step of initially receiving reflected laser beams comprising a plurality of frequencies reflected from said pattern subject to inspection and analyzing an actual position of the pattern subject to inspection from an image obtained in accordance with individually reflected beams.

4. An aligner using a pattern inspecting apparatus, comprising:
an optical frequency shifter for splitting a laser beam emitted from a laser light source into a plurality of laser beams having different frequencies;
an optical member for condensing the plurality of laser beams comprising the different frequencies split by said optical frequency shifter towards a pattern subject to inspection;
an optical detector for receiving reflected laser beams comprising a plurality of frequencies irradiated onto the pattern subject to inspection via said optical member; and
an analyzer for analyzing an actual position of the pattern subject to inspection in accordance with reflected beams received by said optical detector.

5. The aligner according to claim 4, further comprising:
a visible laser light source for emitting visible laser light toward said optical member; and
an observing device for observing an image obtained from reflected beams reflected from the pattern subject to inspection,
wherein said optical member is capable of condensing the visible light emitted from said visible laser light source in conjunction with said laser beams split into plural frequencies by said optical frequency shifter.

6. A method of manufacturing an electronic device, which utilizes a pattern inspection method comprising:
a step of splitting a laser beam emitted from a laser light source into a plurality of laser beams having different frequencies;
a step of initially condensing said plurality of laser beams having different frequencies towards a pattern subject to inspection and irradiating the condensed laser beams onto the pattern subject to inspection; and
a step of initially receiving reflected laser beams comprising a plurality of frequencies reflected from the pattern subject to inspection and analyzing an actual position of the pattern subject to inspection from an image obtained in accordance with individually reflected laser beams.

7. A method of manufacturing an electronic device, comprising:
a step of splitting a laser beam emitted from a laser light source into a plurality of laser beams having different frequencies;
a step of initially condensing the plurality of laser beams having different frequencies towards a pattern subject to inspection and irradiating the condensed laser beams onto the pattern subject to inspection;
a step of initially receiving reflected laser beams comprising a plurality of frequencies reflected from the pattern subject to inspection and analyzing an actual position of the pattern subject to inspection from an image obtained in accordance with individually reflected laser beams; and
a step of repeating predetermined exposing processes in accordance with the analyzed position of the pattern subject to inspection.
